(19) United States
(12) Patent Application Publication
(10) Pub. No.: US 2015/0204323 A1
(43) Pub. Date: Jul. 23, 2015

(54) Compressor Cylinder Head for a Compressor, Vehicle Therewith and Method for Cooling and Producing Such a Compressor Cylinder Head

(71) Applicant: WABCO GmbH, Hannover (DE)

(72) Inventors: Faouzi Bouzidi, Hannover (DE); Achim Bruns, Wedemark (DE); Konrad Feyerabend, Hannover (DE); Andreas Pretsch, Laatzen (DE)

(21) Appl. No.: 14/414,896

(22) PCT Filed: Jun. 29, 2013
(86) PCT No.: PCT/EP2013/001921

§ 371 Date: Jan. 15, 2015

(30) Foreign Application Priority Data
Aug. 10, 2012 (DE) 10 2012 015 906.4

(51) Int. Cl. F04B 53/08; F04B 53/16; F16J 10/02

(52) U.S. Cl. CPC F04B 53/08; F16J 10/02; F04B 53/162

(57) ABSTRACT

A compressor cylinder head with a cylinder head housing (6) and at least one pressure valve (18) has an associated pressure valve channel (17) in the cylinder head housing (6). The pressure valve channel (17) connects a compression chamber (8) arranged below the compressor cylinder head to a pressure chamber (16) inside the compressor cylinder head. Further, the compressor cylinder head has one or more channel portions with a first coolant channel system (24) inside the cylinder head housing (6), which can be filled with a coolant that flows around the pressure chamber (16). Via a casting method, the cylinder head housing (6) is produced integrally with the first coolant channel system (24) arranged therein, and further coolant channels (34) are arranged on either side of the at least one pressure valve channel (17).

### TECHNICAL FIELD

The invention relates to a compressor cylinder head with a cylinder head housing. The invention furthermore relates to a vehicle with a compressor that has the compressor cylinder head and is used to produce compressed air. The invention furthermore relates to a method for cooling the compressor cylinder head and to a method for producing the compressor cylinder head.

### BACKGROUND OF THE INVENTION

Motor vehicles, especially commercial vehicles, increasingly have subsystems which are operated with compressed air. These are brake systems and pneumatic suspension systems, for example. Compressed air is normally supplied by a compressed air supply device, which has a compressor. This compressor draws in ambient air and compresses it. Owing to the compression, the air is heated and transfers heat to the compressor, especially the compressor cylinder head. The compressor cylinder head is therefore normally provided with a cooling system in order to avoid overheating of the compressor cylinder head and to cool the compressed air to an acceptable temperature level for conditioning.

DE 195 35 079 A1 shows a compressor in which coolant chambers designed as channels are arranged in the jacket of the cylinder head, said chambers being connected to one another and via a coolant connection to a coolant source.

In order also to produce the cooling effect in the bottom region of the compressor cylinder head, close to the pressure valve, it is conventional practice to provide separate valve plates, on which the pressure valve is secured.

DE 866 712 shows a valve plate for a compressor, which consists of a plurality of sheets layered one on top of the other. This has the advantage that channels, in particular coolant channels, can be formed when these sheets are layered one on top of the other by making punched holes in the individual sheets. However, the disadvantage here is the relatively complex production method for a valve plate of this kind owing to the additional sealing of the individual sheets relative to one another. It is therefore the underlying object of the invention to provide improved cooling of the compressor cylinder head, especially of the pressure valve channel, and a reduction in the final temperature of the compressed air from the compressor while simultaneously achieving simplicity in the production of a compressor cylinder head of this kind.

In one aspect, the invention achieves the object with a compressor cylinder head which has a cylinder head housing, having at least one pressure valve with an associated pressure valve channel in the cylinder head housing, wherein the pressure valve channel connects a compression chamber arranged under the compressor cylinder head to a pressure chamber inside the compressor cylinder head. The cylinder head housing furthermore has a coolant channel system inside the cylinder head housing, which has one or more channel segments and can be filled with a coolant that flows around the pressure chamber.

According to the invention, the cylinder head housing with the coolant channel system arranged therein has an integral construction which is implemented at low cost via a casting process, in particular via a diecasting process.

The compressor cylinder head according to the invention furthermore has further coolant channels, in particular further coolant channels arranged on each side of the at least one pressure valve channel, wherein each of the further coolant channels is connected at two points to the first coolant channel system.

Via the further coolant channels, direct cooling is advantageously produced in the vicinity of the pressure valve channel, resulting in less heat radiation from the compressor cylinder head to the compressor cylinder and the compressor cylinder walls.

Cooling in the direct vicinity of the pressure valve channel advantageously reduces the deformation of the compressor cylinder and thus ensures better air quality and lower oil consumption. With the compressor cylinder according to the invention, it is likewise advantageously possible to achieve a reduction in coking phenomena and a lower air temperature at the outlet.

The cooling according to the invention via additional further coolant channels in the compressor cylinder head, furthermore leads to a low final compression temperature of the compressed air, something that proves particularly advantageous in respect of the further conditioning of the compressed air, especially drying of the air.

According to a preferred embodiment of the invention, the compressor cylinder head has a cylinder head cover, which is configured to close the cylinder head housing in a pressure tight manner. Moreover, the cylinder head cover forms a pressure tight upper covering for the coolant channel or coolant channels of the first coolant channel system. The compressor cylinder head according to the invention with a cylinder head cover of this kind thus advantageously represents a solution that can be produced in a simple manner since the segment or segments of the first coolant channel system are formed by ribs formed on the bottom of the cylinder head housing during the casting process, which can be closed in a pressure tight manner by the cylinder head cover.

In another preferred embodiment of the invention, the compressor cylinder head has an inlet opening and an outlet opening of the first coolant channel system in the cylinder head housing, wherein the inlet opening and the outlet opening are arranged through a top surface or in the jacket of the cylinder head housing. Here, the inlet opening is used for the inflow of the coolant and the outlet opening is used for the outflow of the coolant from the first coolant channel system. However, the invention is not restricted to one inlet opening and one outlet opening. On the contrary, any number of inlet and/or outlet openings for the connection of further coolant circuits is conceivable. It is furthermore conceivable that the first coolant channels be connected fluidically to the cylinder head housing at the cylinder and that inlet and/or outlet openings be arranged in the region of the cylinder housing.

Through suitable positioning of the inlet and outlet openings, advantageous flow properties of the coolant can advantageously be produced.

According to another embodiment of the invention, the distance between the further coolant channels arranged on each side of the pressure valve channel is less than the length of the pressure valve. The further coolant channels each preferably extend between the pressure valve channel and the fastening element for fastening the pressure valve. However, the invention is not restricted to the use of pressure valves having two fastening elements. If the pressure valve used is a relatively short pressure valve with just one fastening element, a wall thickness of the cylinder head housing between the further coolant channel and the pressure valve channel of 2 mm to 5 mm is maintained according to the invention. By this relatively small distance between the further coolant channels and the pressure valve channel, a large cooling effect is advantageously achieved since cooling takes place directly at the point at which the highest temperatures occur, namely in the bottom of the cylinder head housing at the pressure valve channel.

In another embodiment of the invention, closure of one or more segments of the first coolant channel system is provided, with the result that there is meandering flow of the coolant through the first coolant channel system and the further coolant channels in the bottom of the cylinder head housing. Through the closure of one or more partial segments, a better flow characteristic is advantageously achieved, with the result that boiling of the coolant and associated cavitation are advantageously avoided, even in unfavorable operating states, e.g. a low cooling water flow, a high compressor load and a high temperature due to high speeds of rotation.

In another preferred embodiment of the invention, the compressor cylinder head has external seals in the cylinder head housing at the further coolant channels. These seals are preferably made of balls or covers or caps, which can be pressed and/or adhesively bonded into the opening of the further coolant channels. Here, closure is accomplished with or without a sealant, in particular a liquid sealant for securing the seal. This has the advantage that the further coolant channels leading to the outside in the cylinder head housing are closed in a pressure tight manner and that no coolant can escape.

According to another preferred embodiment of the invention, the further coolant channels have a cross-sectional shape, the wall dimension of which on the side facing the pressure valve channel is greater than the sides of the cross section of the further coolant channel which face upward and downward. In particular, the further coolant channels have an oval or rectangular cross-sectional shape. This has the advantage that a greater cooling effect is achieved at the pressure valve channel through the larger wall surface area close to the pressure valve channel. Since it is possible to exert an influence over the flow velocity of the coolant via the cross-sectional shape, cooling can be improved through a suitable cross-sectional shape, via the regulation of the flow velocity of the coolant.

In another embodiment of the invention, the further coolant channels have different cross sections, in particular different cross-sectional shapes. Given a different wall thickness between the pressure valve channel and the further coolant channel on both sides of the pressure valve channel, it is thus advantageously possible to bring about a correlation between the coolant channel diameter and the associated wall thickness by varying the cross section of the coolant channel. This results in the advantage of uniform cooling of the pressure valve channel, thereby making it possible to avoid deformations of the cylinder.

When using the further coolant channels according to the invention, it is furthermore advantageously possible to regulate a difference in heat input of the different pressure valve channels through different diameters of the further coolant channels. Such regulation of the heat input is particularly advantageous in the case of multistage compressors.

The invention furthermore achieves the abovementioned object with a vehicle, in particular a motor vehicle, which has at least one compressor for producing compressed air, having at least one compressor cylinder head according to the invention.

The invention furthermore achieves the abovementioned object with a method for cooling the compressor cylinder head according to the invention. For this purpose, the coolant is passed through an inlet opening in the cylinder head housing into the first coolant channel system. There, the coolant is passed through at least one segment of the first coolant channel system in the cylinder head housing and through further coolant channels, in particular through respective further coolant channels arranged on each side of the pressure valve channel. The further coolant channels are each connected directly to the first coolant channel system at least at two points. Via an outlet opening, the coolant flows back into a coolant circuit, e.g. the coolant circuit of the internal combustion engine. The arrangement according to the invention of the first coolant channel system and of the further coolant channels advantageously gives rise to a flowing movement in the compressor cylinder head substantially parallel to the cylinder cover surface.

By virtue of the routing of the coolant close to the pressure valve channel, the compressor cylinder head can advantageously be cooled where the highest temperatures occur. As a result, less heating of the cylinder head and thus reduced heating of the cylinder wall can be achieved, this advantageously leading to less deformation of the cylinder and to a reduction in the final compression temperature of the compressed air.

Finally, the invention achieves the abovementioned object via a method for producing the compressor cylinder head according to the invention. For this purpose, the cylinder head housing with the first coolant channel system arranged therein is produced integrally via a casting process, in particular via a diecasting process.

In the casting process, provision is made to produce integrally cast ribs on the bottom of the cylinder head housing to form the first coolant channel system, wherein the first coolant channel system has one or more channel segments. The first coolant channel system produced in this way is situated substantially in the peripheral surface of the cylinder head housing and in any walls of the cylinder head housing which surround the pressure chamber.

Further coolant channels are arranged in the bottom of the cylinder head housing according to the invention, in particular on each side of the at least one pressure valve channel, wherein each of the further coolant channels is connected at least at two points to the first coolant channel system.

A cylinder head housing formed integrally in this way is particularly simple and inexpensive to produce via the diecasting process and the simultaneous or subsequent introduction of the further coolant channels in the vicinity of the pressure valve channels.

According to a preferred embodiment of the invention, the further coolant channels run substantially parallel and are produced transversely in the bottom of the cylinder head housing via slides or core pulls during the diecasting process. With a production method of this kind, conical or frustopyramidal, aerodynamically favorable channel shapes are advantageously possible, with or without finish-machining. During finish-machining, the casting skin formed between the slide and the casting die is finish-machined by milling and/or boring.

In a preferred embodiment of the invention, finish-machining of the further coolant channels is carried out in one working step with a suitable boring tool and/or milling tool. During this process, the coolant channels formed by the slide are smoothed and connected to the first coolant channel system. Such finish-machining advantageously ensures reliable connection of the further coolant channels to the first coolant channel system.

According to an alternative embodiment of the invention, the further coolant channels are produced transversely in the bottom of the cylinder head housing via bores. In this way, low-cost production of the compressor cylinder is achieved. If all the bores have the same diameter and all the bores are parallel, production is particularly inexpensive.

According to another alternative embodiment of the invention, the further coolant channels are produced transversely in the bottom of the cylinder head housing by milling. By milling in this way, different diameters and different shapes in the cross-sectional area, in particular an oval or rectangular cross-sectional area, can be produced. This has the advantage that the flow rate of the coolant at different points can be regulated in order to achieve a specific cooling effect.

Further embodiments and details of the invention will emerge from the illustrative embodiments described in greater detail with reference to the drawing.

### BRIEF DESCRIPTION OF THE DRAWINGS

In the drawing:

FIG. 1 shows a schematic illustration of a compressor cylinder head according to the prior art in a longitudinal section,

FIG. 2 shows a partial illustration of a section through a compressor cylinder head having two pressure valves and

FIG. 3 shows a plan view of a section through the partial illustration of the compressor cylinder head shown in FIG. 2.

### DETAILED DESCRIPTION OF THE DRAWINGS

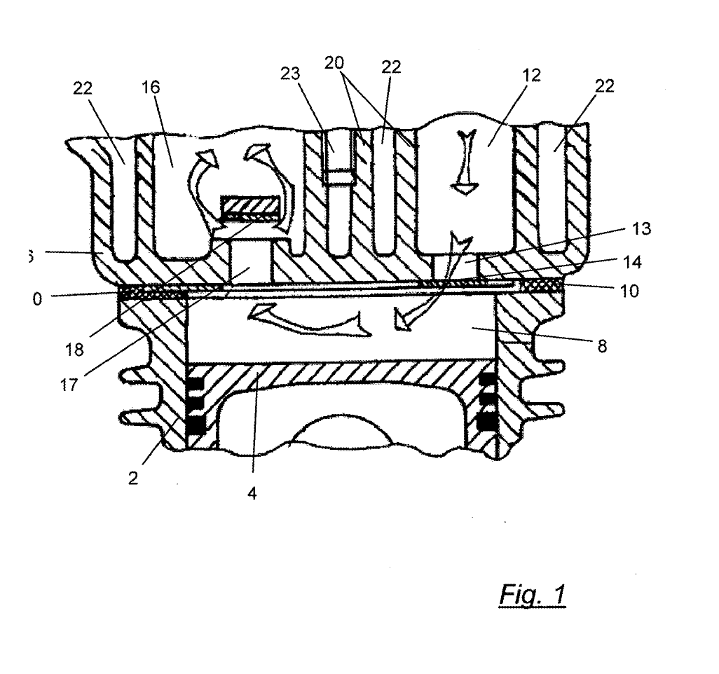

FIG. 1 shows a schematic partial illustration of a compressor for producing compressed air, in particular for air brake devices on motor vehicles in accordance with the prior art.

To produce compressed air, a cylinder 2 is illustrated with a piston 4 that can be moved in the direction of the longitudinal axis of the cylinder 2. Between the piston 4 and the cylinder head housing 6 there is a compression chamber 8, in which induced air is compressed.

The cylinder head housing 6 is connected to the cylinder 2, wherein a cylinder head gasket 10 is arranged between the cylinder head housing 6 and the cylinder 2.

The cylinder head furthermore has a suction chamber 12 and a suction valve channel 13, wherein a suction valve 14 is arranged at the lower end of the suction valve channel 13. Moreover, the cylinder head has a pressure chamber 16 and a pressure valve channel 17, wherein a pressure valve 18 is arranged at the upper end of the pressure valve channel 17.

To cool the pressure chamber 16, coolant channels 22 connected to one another to carry a coolant are arranged in the jacket of the cylinder head housing 6 and in a wall 20 between the pressure chamber 16 and the suction chamber 12.

In order to close the coolant channels 22 from above, the compressor cylinder head has a cylinder head cover (not shown here), which is connected detachably to the cylinder head housing 6 via a hole 23 provided with a thread.

In terms of operation, the air to be compressed is drawn in via the suction chamber 12 and through the suction valve 14 by the downward movement of the piston 4 in the cylinder 2. The air is passed into the compression chamber 8, where it is compressed as the piston 4 moves upward. The compressed air is forced through the pressure valve channel 17 and the pressure valve 18 into the pressure chamber 16, where it is available for a consuming unit (not shown specifically). The operation of the compressor is indicated by arrows in FIG. 1.

During the compression of the air in the compressor, this air is heated up greatly, with the heating increasing as the delivery pressure increases and the speed of rotation of the compressor increases. The radiated heat is transmitted by the compressor cylinder head to the cylinder 2. However, intense heating of the cylinder wall leads to deformations and hence to higher oil consumption. Moreover, coking occurs due to the intense heating. In order to increase the cooling effect produced with the known compressors, the compressor cylinder head according to the invention has further coolant channels.

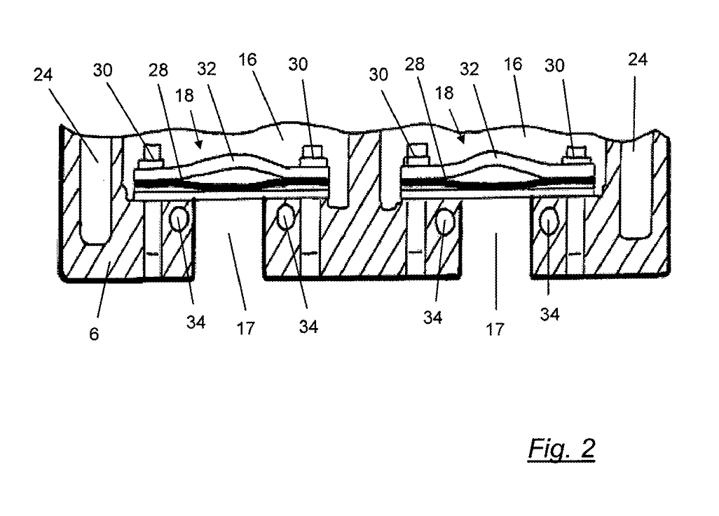

FIG. 2 shows a partial illustration of a section through a compressor cylinder head having two pressure valves in accordance with one illustrative embodiment of the invention. The cylinder head housing 6 is of one-piece construction, in particular comprising an aluminum diecasting. To cool the compressed air in the pressure chambers 16, a first coolant channel system 24 is arranged around the pressure chambers 16 in the cylinder head housing 6, said system consisting of one or more channel segments. The first coolant channel system 24, which is shown in FIG. 2, is closed in a pressure tight manner at the top by a cylinder head cover (not shown here) and has inlet and outlet openings (not shown specifically here).

In a preferred method for producing the compressor cylinder head according to the invention, a casting die which defines the shape of the compressor cylinder head housing 6, of the pressure chamber 16, of the pressure valve channels 17 and of the first coolant channel system 24 is prepared.

The first coolant channel system 24 carries a flow of a gaseous or liquid coolant. In this embodiment of the invention, the coolant is cooling water, particularly water containing additives, e.g. for frost and/or corrosion protection. As an alternative, however, it may also be expedient to use cooling oil instead of cooling water.

The bottom of the cylinder head housing 6 is arranged above the compression chamber 8 of the cylinder 2, with the result that the compressed air is forced through the pressure valve channels 17 and the pressure valves 18. Arranged above each of the pressure valve channels 17 is a valve plate 28, which is held via suitable fastening elements 30. Two valve stops 32 are furthermore illustrated, serving in a known manner to provide a stop for the valve plates 28 (likewise shown) covering the pressure valve channels 17. Fundamentally however, the invention is not restricted to one particular embodiment of the pressure valve 18.

To improve the cooling of the compressor cylinder head and of the compressed air, the compressor cylinder head according to the invention has further coolant channels 34, which are arranged on each side of the pressure valve channel 17. They advantageously cool the surroundings of the pressure valve channel 17, in which most of the heat from the hot air is released into the cylinder head owing to the higher flow velocity of the air.

The further coolant channels 34 are produced by boring or by milling in a transverse direction in the bottom of the cylinder head housing 6 or, alternatively, are allowed for via slides or core pulls during the casting process for the cylinder head housing 6.

If it is not possible to cast the further coolant channels 34 in a suitable way via slides in the casting process during the production of the further coolant channels 34, finish-machining of the further coolant channels 34 is advantageous. Since the cast material also runs slightly between the casting die and the slide, the slide is not brought right up to the coolant channel of the first coolant channel system 24 at the second point of connection of a coolant channel of the further coolant channels 34 to the first coolant channel system 24. In this way, the formation of a casting skin is avoided, at least at the second point of connection.

Finish-machining is carried out after the casting process via a suitable boring and/or milling tool in order to remove the casting skin at the first point of connection of a coolant channel of the further coolant channels 34 to the first coolant channel system 24 and to establish a connection between the further coolant channel 34 and the first coolant channel system 24 at the second point of connection. In this case, finish-machining is preferably performed in a single working step through the opening left behind in the cylinder head housing 6 by the slide, the region of the opening being specially smoothed in order to achieve a better surface finish so that the openings can then be closed in a pressure tight manner.

In order to remove the slides from the workpiece after the casting process, the slides have a cross-sectional shape which tapers along the length of the slides, in particular a conical shape. For finish-machining in a single working step, this requires a suitable boring or milling tool which is matched to the different diameters and cross-sectional shapes of the further coolant channels 34, e.g. a milling tool which has a small cross section at the front and a large cross section at the rear.

However, the invention is not restricted to the illustrative embodiment described above for the finish-machining of the further coolant channels 34. On the contrary, finish-machining can also be performed from above through the first coolant channel system 24 with a suitable milling tool. However, this requires several working steps for the finish-machining of each coolant channel of the further coolant channels 34.

It is furthermore also conceivable to produce all the points of connection between the coolant channel 34 and the first coolant channel system 24 via the slide.

Finally, by smoothing the further coolant channels 34, finish-machining advantageously ensures better coolant flow properties.

To ensure that the further coolant channels 34 are as close as possible to the pressure valve channel 17, they are preferably arranged between the pressure valve channel 17 and the fastening elements 30 of the pressure valve 18. However, the invention is not restricted to such an arrangement of the further coolant channels 34. On the contrary, any arrangement of the further coolant channels 34 in the vicinity of the pressure valve channel 17 is conceivable, ensuring that the distance between the further coolant channels 34 arranged on both sides of the pressure valve channel 17 is less than the length of the associated pressure valve 18.

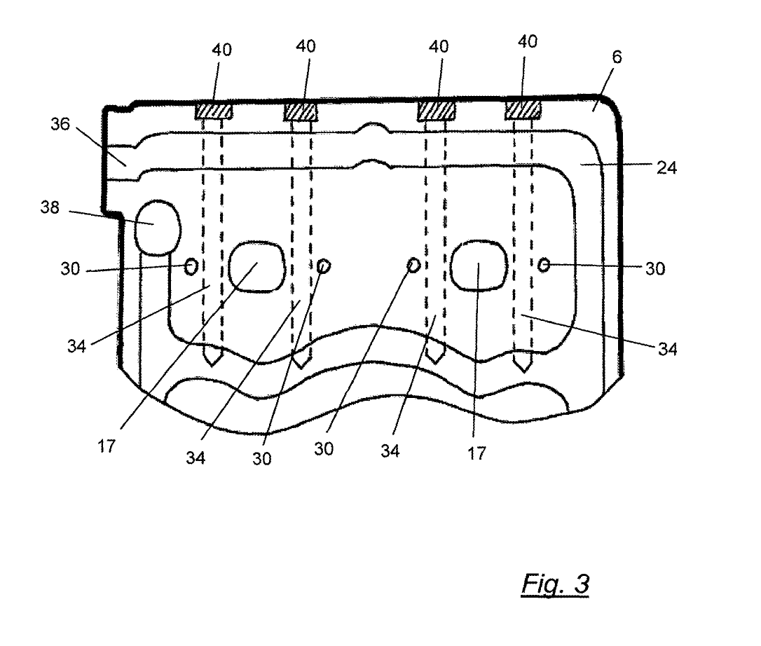

FIG. 3 shows a plan view of a section through the partial illustration of the compressor cylinder head according to the invention shown in FIG. 2. The coolant flows through an inlet opening 36 into the first coolant channel system 24 in the cylinder head housing 6. The coolant channel system 24 is designed in such a way that the coolant flows around the pressure chambers 16 (see FIG. 2) situated above the pressure valve channels 17. After flowing through the compressor cylinder head, the coolant flows out of said head through an outlet opening 38.

According to FIG. 3, the first coolant channel system 24 is connected to further coolant channels 34. In the illustrative embodiment shown in FIG. 3, the further coolant channels 34 are substantially parallel bores extending transversely in the bottom of the cylinder head housing 6. The bores run between the pressure valve channel 17 and the fastening elements 30 of the pressure valve 18 in such a way that they form a connection to the first coolant channel system 24 at two points.

The further coolant channels 34 preferably have constrictions to ensure adequate flow of the coolant through the further coolant channels 34. As an alternative, it is also possible for individual segments of the first coolant system 24 to be closed, ensuring that the coolant is guided along a meandering path through the first coolant channel system 24 and the further coolant channels 34. It is also conceivable to form the first coolant channel system 24 during the casting process itself in such a way that only individual partial segments of the first coolant channel system 24 are produced. This has the advantage that there is no need for subsequent closure of any segments of the first coolant channel system 24.

The diameter of a coolant channel affects the flow velocity and flow rate of the coolant and hence the cooling effect. The diameter of the further coolant channels 34 can be matched to the position of the respective coolant channel, for example. If there is a difference in wall thickness between the pressure valve channel 17 and the further coolant channel 34 on each side of the pressure valve channel 17, correlation of the coolant channel diameter and wall thickness can be performed, ensuring that the same cooling effect is achieved on both sides of the pressure valve channel 17. The uniform cooling effect has an advantageous effect on any deformations of the cylinder 2.

If the compressor cylinder head according to the invention is a cylinder head for a multistage compressor, different heat outputs at the various pressure valve channels 17 can be regulated through different diameters of the further coolant channels 34.

The bore openings in the cylinder head housing 6 are closed with respect to the outside by seals 40, in particular balls or covers. The seals 40 are pressed or adhesively bonded into the bore openings, and a liquid sealant can be used for additional sealing.

Thus, the coolant flows not only through the first coolant channel system 24 in the manner indicated above but also flows through the further coolant channels 34 in the vicinity of the pressure valve channels 17. As a result, the cooling effect of the compressor cylinder head according to the invention is improved over a conventional compressor cylinder head while simultaneously allowing simple and low-cost production.

However, the invention is not restricted to bored parallel further coolant channels 34. On the contrary, the further coolant channels 34 can be designed in any desired way, depending on requirements.

Through milling or when using suitable slides in the casting process, it is possible to achieve any desired cross-sectional shapes of the further coolant channels 34, for example. The invention has recognized that a larger wall surface area is produced near the pressure valve channel 17 and hence a greater cooling effect can be achieved with an oval or rectangular cross-sectional shape.

The compressor cylinder head according to the invention can be designed for a single cylinder compressor or a multicylinder compressor. In the case where the compressor is a multicylinder compressor, the further coolant channels 34 are arranged on all the cylinders in order to achieve a uniform cooling effect. If the compressor is a multistage compressor, the further coolant channels can be arranged on individual compressor stages or on all the compressor stages, depending on requirements.

All the features mentioned in the above description and in the claims can be used in accordance with the invention, both individually and in any combination. The disclosure of the invention is therefore not restricted to the combinations of features described or claimed. On the contrary, all combinations of individual features are to be regarded as disclosed.

1. A compressor cylinder head with a cylinder head housing (6), having at least one pressure valve (18) with an associated pressure valve channel (17) in the cylinder head housing (6), wherein the pressure valve channel (17) connects a compression chamber (8) arranged under the at least one pressure valve to a pressure chamber (16) inside the compressor cylinder head, and a first coolant channel system (24) inside the cylinder head housing (6), which has one or more channel segments and can be filled with a coolant that flows around the pressure chamber (16), wherein
the cylinder head housing (6) with the first coolant channel system (24) arranged therein is produced integrally via a casting process, and
further coolant channels (34) are arranged in the cylinder head housing (6) on each side of the at least one pressure valve channel (17), wherein each of the further coolant channels (34) is connected at least at two points to the first coolant channel system (24).

2. The compressor cylinder head as claimed in claim 1, further comprising a cylinder head cover, which is configured to close the cylinder head housing (6) and the first coolant channel system (24) in a pressure tight manner.

3. The compressor cylinder head as claimed in claim 1, further comprising an inlet opening (36) and an outlet opening (38) of the first coolant channel system (24) in the cylinder head housing (6) for the inflow and outflow of the coolant, wherein the inlet opening (36) and the outlet opening (38) are arranged through a top surface or in a jacket of the cylinder head housing (6).

4. The compressor cylinder head as claimed in claim 1,
characterized in that wherein
between the two further coolant channels (34) arranged on each side of the pressure valve channel (17) is a distance less than a length of the pressure valve (18) associated with the pressure valve channel (17),
or a wall thickness of the cylinder head housing (6) between the further coolant channel (34) and the pressure valve channel (17) is 2 mm to 5 mm.

5. The compressor cylinder head as claimed in claim 1,
further comprising closures to form segments in the first coolant channel system (24) in such a way that there is meandering flow of the coolant through the first coolant channel system (24) and the further coolant channels (34).

6. The compressor cylinder head as claimed in claim 1, further comprising seals (40) for openings in the cylinder head housing (6) of the further coolant channels (34), which are pressed in or adhesively bonded or both pressed in and adhesively bonded.

7. The compressor cylinder head as claimed in claim 1, wherein the further coolant channels (34) have a cross-sectional shape with a wall dimension on the side facing the pressure valve channel (17) being greater than wall dimensions facing upward and downward.

8. The compressor cylinder head as claimed in claim 1, wherein the further coolant channels (34) have different cross sections.

9. A motor vehicle comprising a compressor for producing compressed air, having a compressor cylinder head as claimed in claim 1.

10. A method for cooling a compressor cylinder head, wherein the compressor cylinder head has a cylinder head housing (6), having at least one pressure valve (18) with an associated pressure valve channel (17), which connects a compression chamber (8) arranged under the compressor cylinder head to a pressure chamber (16) inside the compressor cylinder head, and a first coolant channel system (24) inside the cylinder head housing (6), which has one or more channel segments and is filled with a coolant that flows around the pressure chamber (16), wherein the coolant is passed through at least a segment of the first coolant channel system (24) and of further coolant channels (34) arranged on sides of the at least one pressure valve channel (17).

11. A method for producing a compressor cylinder head, wherein the compressor cylinder head has a cylinder head housing (6), having at least one pressure valve (18) with an associated pressure valve channel (17), which connects a compression chamber (8) arranged under the compressor cylinder head to a pressure chamber (16) inside the compressor cylinder head, and a first coolant channel system (24) inside the cylinder head housing (6), which has one or more channel segments and can be filled with a coolant that flows around the pressure chamber (16),
characterized in that wherein
the cylinder head housing (6) with the first coolant channel system (24) arranged therein is produced integrally via a casting process, and
further coolant channels (34) are arranged in the cylinder head housing (6) on sides of the at least one pressure valve channel (17), wherein each of the further coolant channels (34) is connected at least at two points to the first coolant channel system (24).

12. The method as claimed in claim 11, wherein the further coolant channels (34) run substantially parallel and are produced via slides or core pulls during the casting process for the cylinder head housing (6).

13. The method as claimed in claim 12, wherein finish-machining of the further coolant channels (34) is carried out in one working step with a suitable boring tool and/or milling tool, wherein the further coolant channels (34) formed by the slide are smoothed and connected to the first coolant channel system (24).

14. The method as claimed in claim 11,
wherein the further coolant channels (34) are produced via bores in the cylinder head housing (6).

15. The method as claimed in claim 11,
wherein the further coolant channels (34) in the cylinder head housing (6) are produced via a milling process.

16. The compressor cylinder head as claimed in claim 1 wherein a wall thickness of the cylinder head housing (6) between the further coolant channel (34) and the pressure valve channel (17) is 2 mm to 5 mm.

17. The compressor cylinder head as claimed in claim 7 wherein the cross-sectional shape is an oval or a rectangular shape.
